(19) United States
(12) Patent Application Publication
(10) Pub. No.: US 2006/0109063 A1
(43) Pub. Date: May 25, 2006

(54) Matching for ring hybrid

(75) Inventors: Gerardo Aguirre, San Diego, CA (US); Paul Garland, San Diego, CA (US)

Correspondence Address: HOGAN & HARTSON L.L.P., 500 S. GRAND AVENUE, SUITE 1900, LOS ANGELES, CA, 90071-2611, US

(73) Assignee: Kyocera America, Inc.

(21) Appl. No.: 10/996,931

(22) Filed: Nov. 23, 2004

(51) Int. Cl. H01P 5/22

(52) U.S. Cl. 333/120

(57) ABSTRACT

A ring hybrid circuit achieves broadband matching in a compact, small footprint configuration which allows all matching structures to be printed on the same surface layer as the ring hybrid. The circuit includes a power dividing ring of circular configuration and having an inner diameter. A plurality of transmission lines are coupled to the ring at ports. Each of the ports has a notch in the inner diameter of the ring opposite the transmission line at the port for providing reactance compensation. The ring is provided with four ports, with each of the ports having a notch in the inner diameter of the ring opposite an associated one of the plurality of transmission lines. The ring may be constructed of a 50 ohm line, and each of the transmission lines may include a 42 ohm quarter-wave matching section extending out from the port thereof and terminating in a 50 ohm line.

### BACKGROUND OF THE INVENTION

1. Field of the Invention

The present invention relates to ring hybrid circuits, and more particularly to arrangements for providing broadband matching of a ring hybrid and the port transmission lines thereof.

2. History of the Prior Art

It is known to provide a ring hybrid circuit in which a power dividing ring has a plurality of transmission lines coupled thereto at ports. A typical ring hybrid or “rat-race” circuit consists of a 540° ring with four ports at which transmission lines are attached. Such circuits function as power combiners or power splitter circuits. To achieve broadband matching in such circuits, short low-impedance lines and quarter-wave matching sections can be used. However, this approach provides a circuit with an increased RF footprint. Another approach to achieving broadband matching in such ring hybrid circuits is to replace the three-quarter wave section and introduce a quarter-wave slot line to achieve 270° phase shift independent of frequency to the first order. A disadvantage of this approach is that it is limited in effectiveness to microstrip ring hybrids and requires additional processing and fine feature printing on a second layer surface.

Examples of such prior art arrangements include U.S. Pat. No. 4,316,160 of Dydyk, which describes an impedance transforming hybrid ring with non-uniform impedance ring structure coupled to four ports, two of which are input ports and two of which are output ports. An arbitrary relationship exists between the impedance of the input ports and the impedance of the output ports. Power division between the output ports may be selected as a matter of design choice. A broadband phase reversing network is utilized to provide an impedance transforming hybrid ring which efficiently operates over octave bandwidths.

U.S. Pat. No. 4,578,652 of Sterns describes a broadband TEM mode 4-port hybrid in a single-level microwave circuit in a transmission line medium. The device employs coupled strip all-pass filter elements to provide a hybrid wherein isolation to the cross-ports, power division to the coupled ports, and the 0° and 180° output phase relationships are independent of frequency over substantial frequency bandwidths.

Other examples in the prior art are provided by U.S. Application 2003/0060182 of Nibe, U.S. Pat. No. 5,903,827 of Kennan et al., U.S. Pat. No. 5,237,294 of Roederer et al., U.S. Pat. No. 5,208,563 of Russell et al., U.S. Pat. No. 4,749,969 of Boire et al., U.S. Pat. No. 4,654,887 of Murphy et al., U.S. Pat. No. 4,636,755 of Gibbs, U.S. Pat. No. 4,420,839 of Hogerheiden, Jr., U.S. Pat. No. 4,419,635 of Reindel, U.S. Pat. No. 2,977,484 of Sterzer et al., Japanese Publications 58161502A of Naito et al., and Japanese Publication 63173401A of Kushihi.

In view of the shortcomings of the prior art, it would be desirable to provide a ring hybrid circuit in which broadband matching is achieved in a small footprint. Desirably, such a circuit should allow for all of the matching structures to be printed on the same surface layer as the ring hybrid.

### BRIEF DESCRIPTION OF THE INVENTION

The present invention provides an improved ring hybrid circuit in which broadband matching is accomplished in a small footprint. The circuit allows all matching structures to be printed on the same surface layer as the ring hybrid.

In a preferred embodiment of a ring hybrid circuit according to the invention, a power dividing ring is provided which has a circular configuration and an inner diameter. A plurality of transmission lines are coupled to the ring at individual ports. In accordance with the invention, broadband matching is accomplished by providing at least one of the ports with a notch in the inner diameter of the ring opposite the transmission line. The notch provides reactance compensation, and eliminates the need for additional traces and matching sections. The notch compensates for impedance mismatches and eliminates the reactive part of impedance at a particular frequency. This allows for broadband performance up to 70% in a small footprint. It also allows for inclusion of 50-ohm transmission line dimensions for the ring hybrid rather than the standard 70.7 ohm line dimensions. In this manner, insertion loss RF performance is improved.

In ring hybrid circuits according to the invention, such circuits are preferably provided with a notch at the inner diameter of the ring at each of the ports where the plural transmission lines are coupled to the ring. In a preferred embodiment, the power dividing ring has four ports, each having a notch in the inner diameter of the ring and coupling one of four transmission lines to the ring.

In the ring hybrid circuit according to the invention, the ring may comprise a 50 ohm line, and each of the plurality of transmission lines may comprise a 42 ohm quarter-wave matching section extending outwardly from the port thereof and terminating in a 50 ohm line. The ring and the plural transmission lines are printed on a common surface layer, and the reactance compensating notches are printed on the common surface layer.

In accordance with a method for providing matching in a ring hybrid circuit according to the invention, a power dividing ring is provided. A plurality of transmission lines are also provided, such that each transmission line is coupled to the ring at a different one of a plurality of ports. In accordance with the invention, an inner diameter of the ring is provided with a reactance compensation notch at each of the plurality of ports. Such process in accordance with the invention may include the further step of providing each of the plurality of transmission lines with a quarter-wave matching section at the port where the transmission line is coupled to the ring.

### BRIEF DESCRIPTION OF THE DRAWINGS

FIG. 1 is a plan view of a conventional ring hybrid circuit.

FIG. 2 is a plan view of a ring hybrid circuit in accordance with the invention.

FIG. 3 is a plan view of a portion of the view of FIG. 2 showing one of the ports of the circuit of FIG. 2 in greater detail.

FIG. 4 is a chart of insertion loss plotted as a function of frequency and illustrating energy output at a port that splits power in the circuit of FIG. 2.

FIG. 5 is a chart of return loss plotted as a function of frequency and illustrating energy reflected as a function of power input in the circuit of FIG. 2.

### DETAILED DESCRIPTION OF THE PREFERRED EMBODIMENT

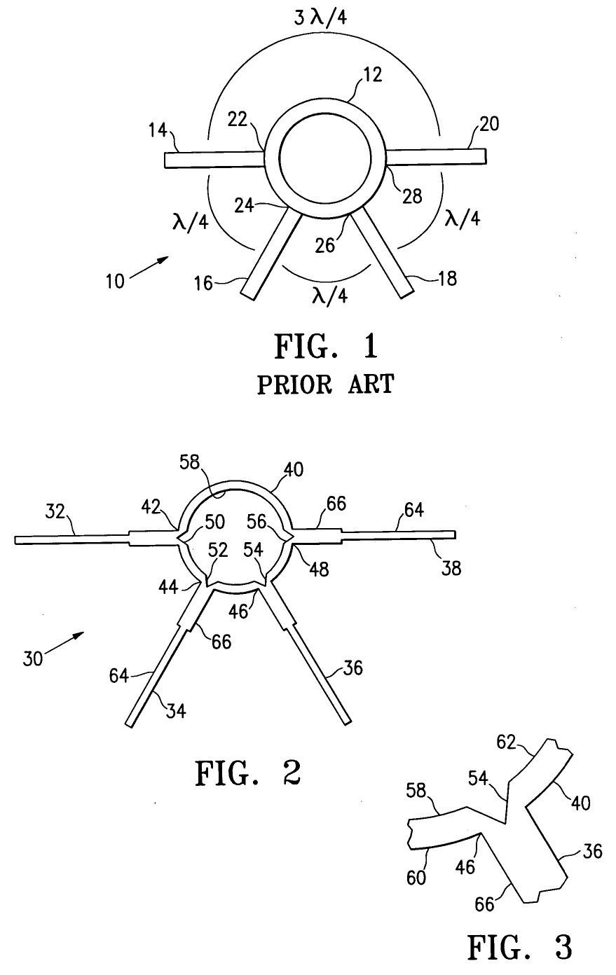

FIG. 1 shows a conventional ring hybrid circuit 10. The conventional ring hybrid circuit 10 of FIG. 1 includes a power dividing ring 12 having a plurality of transmission lines 14, 16, 18 and 20 coupled to the ring 12 at ports 22, 24, 26 and 28 respectively. Typically, the power dividing ring 12 and the transmission lines 14, 16, 18 and 20 comprise conductors which are sandwiched between dielectric members and ground planes (a stripline configuration). Also, typically, the power dividing ring is comprised of conductors over a single dielectric and a single ground plane (a miscrostrip configuration).

Conventional ring hybrid circuit 10 of FIG. 1 is a nominal “rat-race” circuit consisting of a 540′ ring with the ports 22, 24, 26 and 28 located around the circumference thereof. Adjacent transmission lines 14 and 16 are separated by a quarter wavelength (λ/4), as are the transmission lines 16 and 18, and the lines 18 and 20. The transmission lines 14 and 20 are separated by three-quarters wavelength (3λ/4). For typical applications, the transmission lines 14 and 18 provide power inputs, and the transmission line 20 is an isolated port. Power which is inputted via the transmission line 16 is split equally between the lines 14 and 18, with the line 20 receiving no power in the ideal case.

Typically, conventional ring hybrid circuits such as the circuit 10 will have a 20% bandwidth. To achieve broadband matching, various prior art techniques are typically employed, including use of a short low-impedance line and quarter-wave matching sections. Alternatively, the three quarter-wave section may be replaced and a quarter-wave slot line may be introduced to achieve 270° phase shift independent of frequency to the first order. The drawbacks of such prior art solutions to achieve broadband matching were previously discussed.

FIG. 2 shows a ring hybrid circuit 30 in accordance with the invention. Like the ring hybrid circuit 10 of FIG. 1, the ring hybrid circuit 30 of FIG. 2 includes four transmission lines 32, 34, 36 and 38 coupled to a dividing ring 40 at ports 42, 44, 46 and 48 respectively. However, unlike the ring hybrid circuit 10 of FIG. 1, the ring hybrid circuit 30 is provided with a compact arrangement which achieves broadband matching in a small footprint. Moreover, such arrangement allows for all matching structure to be printed on the same surface layer as the ring hybrid circuit 30.

As shown in FIG. 2, the broadband matching arrangements of the ring hybrid circuit 30 comprise a series of notches 50, 52, 54 and 56 at the ports 42, 44, 46 and 48 respectively. Each of the notches 50, 52, 54 and 56 is formed in an inner diameter 58 of the power dividing ring 40. The notches 50, 52, 54 and 56 are reactance compensation notches which compensate for impedance mismatches. The notches 50, 52, 54 and 56 eliminate the reactive part of impedance at a particular frequency. These notches, being small features relative to frequency wavelength, allow broadband performance up to 70%.

As shown in FIG. 2, the power dividing ring 40 is comprised of a 50 ohm line. Each of the transmission lines 32, 34, 36 and 38 is comprised of a 50 ohm line which expands to a 42 ohm quarter-wave matching section as it extends into a respective one of the ports 42, 44, 46 and 48. Such arrangement allows for the inclusion of 50 ohm transmission line dimensions for the ring hybrid circuit 30 instead of the more usual 70.7 ohm dimensions. A 50 ohm line is wider than a 70.7 ohm line, and as a result, insertion loss RF performance is improved.

The port 46 is shown in enlarged fashion in FIG. 3. As shown therein, the transmission line 36 has a 42 ohm quarter-wave matching section extending outwardly from the port 46. The power dividing ring 40 has 50 ohm line sections 60 and 62 thereof extending away from the port 46 on opposite sides thereof. As also shown in FIG. 3, the notch 54 is generally V-shaped and extends into the port 46 from the inner diameter 58 of the power dividing ring 40.

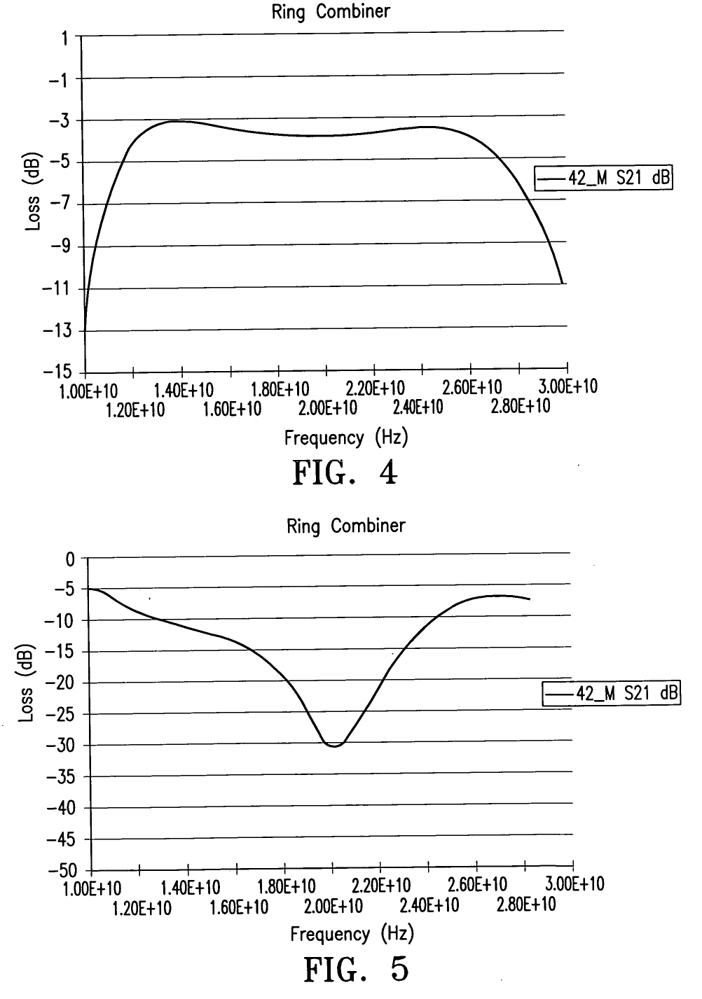

FIGS. 4 and 5 are diagrammatic plots of the operation of the ring hybrid circuit 30 in accordance with the invention. The chart of FIG. 4 shows the energy output at a power splitting port such as the port 44. As shown in FIG. 4, the loss in dB quickly changes from approximately −12 dB at a frequency of 1.00 E+10 Hz to a value close to −3 dB at a frequency of approximately 1.40 E+10 Hz. As the frequency continues to increase, the plot dips slightly and then rises again before rapidly decreasing to a loss of approximately −11 dB at a frequency of 3.00 E+10 Hz.

The chart of FIG. 5 depicts energy reflected as a function of output power in the ring hybrid circuit 30 of FIG. 2. As shown in FIG. 5, the loss decreases from approximately −5 dB at a frequency of 1.00 E+10 Hz to a minimum value of approximately −30 dB at a frequency of slightly more than 2.00 E+10 Hz. Thereafter, as the frequency increases, the loss again rises to a value of approximately −7 dB. The minimum loss value of approximately −30 dB shown in FIG. 5 represents approximately 0.1% reflected power. At this point, very little power is reflected back.

The power dividing ring 40 is comprised of a 50 ohm line, as are outer portions 64 of each of the transmission lines 32, 34, 36 and 38. At the same time, each of the transmission lines 32, 34, 36 and 38 is provided with a 42 ohm quarter-wave matching section 66 which extends from the outer portion 64 into a respective one of the ports 42, 44, 46 and 48.

It will be appreciated by those skilled in the art, as exemplified by the charts of FIGS. 4 and 5, that the notches 50, 52, 54 and 56 of the ring hybrid circuit 30 provide broadband matching in a very small footprint configuration, as well as in a configuration in which all matching structures can be printed on the same surface layer as the ring hybrid circuit 30.

The presently disclosed embodiment is to be considered in all respects as illustrative and not restrictive, the scope of the invention being indicated by the appending claims, rather than the foregoing description, and all changes which come within the meaning and range of equivalency of the claims are therefore intended to be embraced herein.

I claim:

1. A ring hybrid circuit comprising:
a power dividing ring of circular configuration and having an inner diameter;
a plurality of transmission lines coupled to the ring at ports; and
at least one of the ports having a notch in the inner diameter of the ring opposite the transmission line coupled to the port.

2. A ring hybrid circuit according to claim 1, wherein the ring has four ports, each of which has a notch in the inner diameter of the ring opposite one of the plurality of transmission lines coupled to the port.

3. A ring hybrid circuit according to claim 1, wherein each of the ports has a notch in the inner diameter of the ring opposite the transmission line coupled to the port.

4. A ring hybrid circuit according to claim 3, wherein the ring comprises a 50 ohm line, and each of the plurality of transmission lines comprises a 42 ohm quarter-wave matching section extending out from the port thereof and terminating in a 50 ohm line.

5. A ring hybrid circuit comprising:
a power dividing ring;
a plurality of transmission lines, each coupled to the ring at one of the plurality of ports; and
means at each of the plurality of ports for providing reactance compensation.

6. A ring hybrid circuit according to claim 5, wherein the ring and the plurality of transmission lines are printed on a common surface layer, and the means for providing reactance compensation is printed on the common surface layer.

7. A ring hybrid circuit according to claim 5, wherein the means at each of the plurality of ports for providing reactance compensation comprises a notch in an inner diameter of the ring opposite the transmission line at the port.

8. A ring hybrid circuit according to claim 5, wherein each of the plurality of transmission lines includes a quarter-wave matching section at the port thereof.

9. A process for providing matching in a ring hybrid circuit comprising the steps of:
providing a power dividing ring;
providing a plurality of transmission lines, each coupled to the ring at a different one of a plurality of ports; and
forming a reactance compensation notch in an inner diameter of the ring at each of the plurality of ports.

10. A process according to claim 9, including the further step of forming each of the plurality of transmission lines of a quarter-wave matching section at the port where the transmission line is coupled to the ring.
